(19) United States
(12) Patent Application Publication
(10) Pub. No.: US 2017/0004269 A1
(43) Pub. Date: Jan. 5, 2017

(54) SYSTEMS AND METHODS FOR ESTIMATING MENTAL HEALTH ASSESSMENT RESULTS

(71) Applicant: BWW Holdings, Ltd., London (GB)

(72) Inventor: Gavin Potter, London (GB)

(73) Assignee: BWW Holdings, Ltd., London (GB)

(21) Appl. No.: 15/198,016

(22) Filed: Jun. 30, 2016

Related U.S. Application Data
(60) Provisional application No. 62/186,758, filed on Jun. 30, 2015.

(51) Int. Cl. G06F 19/00; G06N 99/00

(52) U.S. Cl. CPC G06F 19/345; G06N 99/005

(57) ABSTRACT

An online service that provides functionality for users to receive an assessment regarding their mental state, a user information database that stores information regarding interactions of the users with the online service, and a system that makes determination the mental states of users based on the interactions of the users with the online service.

### CROSS-REFERENCE TO RELATED APPLICATIONS

This application claims priority from U.S. Provisional Patent Application No. 62/186,758, filed on Jun. 30, 2015, which is incorporated by reference as if fully rewritten herein.

### BACKGROUND

The present specification generally relates to systems and methods for estimating mental health assessment results and, more specifically, to systems and methods for estimating mental health assessment results from user interactions with a user interface.

Unless otherwise indicated herein, the materials described in this section are not prior art to the claims in this application and are not admitted to be prior art by inclusion in this section.

Mental health questionnaires can be administered using a server or client device. The mental health questionnaires can provide an automated and relatively reliable measure of a mood disorder. However, some people simply refuse to participate in mental health questionnaires, while others, for a wide range of reasons, cannot complete mental health questionnaires. Indeed, in many cases users may not wish to spend time to respond to questionnaires because of their formal and clinical nature. Additionally, even when assured anonymity, some users may be reluctant to share personal feelings and information.

Accordingly, a need exists for alternative systems and methods for estimating mental health assessment results from user interactions with a user interface.

### SUMMARY

In one embodiment, a system for estimating mental health assessment results can include a data store, an assessment model, and a server. The data store can include interface element data defining visually perceptible elements and a user information database defining interaction information and mental health assessment results for a plurality of users. The mental health assessment results can be indicative of at least one mental state. The assessment model can be trained to map the interaction information of the user information database to the mental health assessment results of the user information database. The server can be communicatively coupled to the assessment model and the data store. The server can execute machine readable instructions to retrieve the visually perceptible elements from the interface element data of the data store. A user interface including the visually perceptible elements can be provided upon a display of a client device. Data indicative of user interaction with the user interface can be received by the server. The data indicative of user interaction can be input to the assessment model. A mental health estimate can be determined using the assessment model. The mental health estimate can estimate the mental health assessment results of the user information database.

In another embodiment, a method for estimating mental health assessment results can include providing a data store. The data store can include interface element data defining visually perceptible elements and a user information database defining interaction information and mental health assessment results for a plurality of users. The mental health assessment results can be indicative of at least one mental state. An assessment model can be provided. The assessment model can be trained to map the interaction information of the user information database to the mental health assessment results of the user information database. The visually perceptible elements can be retrieved, automatically with a server, from the interface element data of the data store. The server can be communicatively coupled to the assessment model and the data store. A user interface including the visually perceptible elements can be provided, automatically with the server, upon a display of a client device. Data indicative of user interaction with the user interface can be received automatically with the server from the client device. The data indicative of user interaction can be input, automatically with the server, to the assessment model. A mental health estimate can be determined using the assessment model. The mental health estimate can estimate the mental health assessment results of the user information database.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a system according to one or more embodiments shown and described herein;

FIG. 2 schematically depicts a client device of the system of FIG. 1 system according to one or more embodiments shown and described herein;

FIG. 3 schematically depicts a data store of the system of FIG. 1 system according to one or more embodiments shown and described herein;

FIG. 4 schematically depicts a database of the data store of FIG. 3 according to one or more embodiments shown and described herein;

FIG. 5 schematically depicts a self-assessment questionnaire according to one or more embodiments shown and described herein;

FIG. 6 schematically depicts another self-assessment questionnaires according to one or more embodiments shown and described herein;

FIG. 7 schematically depicts a user interface according to one or more embodiments shown and described herein;

FIG. 8 schematically depicts another user interface according to one or more embodiments shown and described herein;

FIG. 9 schematically depicts yet another user interface according to one or more embodiments shown and described herein;

FIG. 10 schematically depicts a method for training an assessment model according to one or more embodiments shown and described herein;

FIG. 11 graphically depicts 2-grams used by users with PHQ-9 scores greater than or equal to 20 according to according to one or more embodiments shown and described herein;

FIG. 12 graphically depicts a view identifying users that the system has determined to have a high probability of severe depression according to one or more embodiments shown and described herein;

FIG. 13 graphically depicts the number of user submissions of self-administered questionnaires by time of day comparing users receiving a score great than or equal to 20 and users receiving a score less than 20 according to one or more embodiments shown and described herein;

FIG. 14 graphically depicts the relative number of user submissions of self-administered questionnaires comparing users receiving a score great than or equal to 20 and users receiving a score less than 20 by time of day according to one or more embodiments shown and described herein;

FIG. 15 graphically depicts the number of user submissions of self-administered questionnaires by day of the week comparing users receiving a score great than or equal to 20 and users receiving a score less than 20 according to one or more embodiments shown and described herein; and

FIG. 16 graphically depicts the relative number of user submissions of self-administered questionnaires comparing users receiving a score great than or equal to 20 and users receiving a score less than 20 by day of the week according to one or more embodiments shown and described herein.

### DETAILED DESCRIPTION

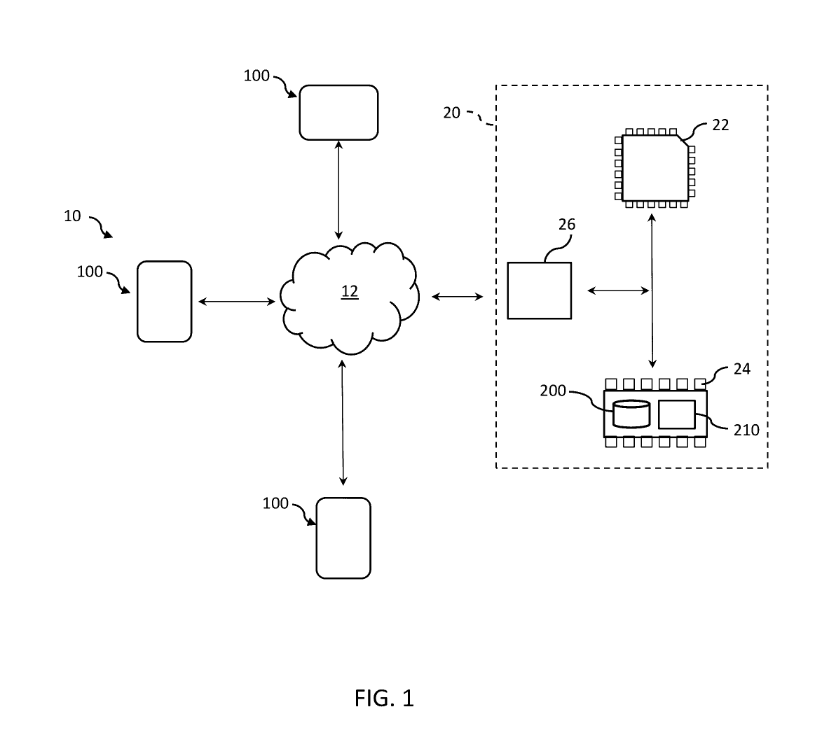

FIG. 1 generally depicts one embodiment of a system for providing an online support and recovery network. The network can be configured to provide a community of members who support each other. For example, the users can be people who are stressed, anxious, or not coping properly. The network may allow users to share their thoughts and feelings in an anonymous environment. The network may also offer guidance from trained professionals. The system generally includes a server communicatively coupled to one or more client devices. Various embodiments of the system and the operation of the system will be described in more detail herein.

Referring again to FIG. 1, a system 10 for providing an online support and recovery network can include one or more servers 20 for hosting an enterprise application for automatically providing an online support and recovery network. The server 20 can include one or more processors 22. As used herein, the term “processor” can mean any device capable of executing machine readable instructions. Accordingly, each processor can be a controller, an integrated circuit, a microchip, or any other device capable of implementing logic.

The server 20 can include memory 24 communicatively coupled to the one or more processors 22. As used herein, the phrase “communicatively coupled” can mean that components are capable of exchanging data signals with one another such as, for example, electrical signals via conductive medium, electromagnetic signals via air, optical signals via optical waveguides, and the like. The memory 24 described herein can include any non-transitory computer-readable storage medium such as, for example, RAM, ROM, a flash memory, a hard drive, or any device capable of storing machine readable instructions.

Additionally, it is noted that the functions, modules, and processes described herein can be provided as machine readable instructions stored on the memory 24 and executed by the one or more processors 22. The machine readable instructions can be provided in any programming language of any generation (e.g., 1GL, 2GL, 3GL, 4GL, or 5GL) such as, e.g., machine language that can be directly executed by the processor, or assembly language, object-oriented programming (OOP), scripting languages, microcode, etc., that can be compiled or assembled into machine readable instructions and stored on a machine readable medium. Alternatively, the functions, modules, and processes described herein can be written in a hardware description language (HDL), such as logic implemented via either a field-programmable gate array (FPGA) configuration or an application-specific integrated circuit (ASIC), and their equivalents. Accordingly, the functions, modules, and processes described herein can be implemented in any conventional computer programming language, as pre-programmed hardware elements, or as a combination of hardware and software components.

The one or more processors 22 can also be communicatively coupled to network interface hardware 26 for communicatively coupling the server 20 to another device via a network such as, for example, a wide area network, a local area network, personal area network, and combinations thereof. Accordingly, the network interface hardware 26 can be configured to communicate, i.e., send and/or receive data signals via any wired or wireless communication protocol. For example, the network interface hardware 26 can include an antenna, a modem, LAN port, wireless fidelity (Wi-Fi) card, WiMax card, near-field communication hardware, satellite communication hardware, or the like. Accordingly, the server 20 can be communicatively coupled to a network via wires, via a wide area network, via a local area network, via a personal area network, via a satellite network, or the like. Suitable local area networks can include wired ethernet and/or wireless technologies such as, for example, Wi-Fi. Suitable personal area networks can include wireless technologies such as, for example, IrDA, BLUETOOTH, Wireless USB, Z-WAVE, ZIGBEE, or the like. Alternatively or additionally, suitable personal area networks can include wired computer buses such as, for example, USB and FIREWIRE. Thus, any components of the server 20 can utilize one or more network components to communicate signals via the internet 12.

In some embodiments, the one or more processors 22 can execute web server software provided as machine readable instructions that can be, for example, stored on the memory 24. Suitable web server software includes, but is not limited to, Apache HTTP Server, Internet Information Services, Nginx, Google Web Server, or the like. Accordingly, the server 20 can utilize a server operating system such as, for example, Unix, Linux, BSD, Microsoft Windows, or the like. In some embodiments, the server 20 can be configured to be communicatively coupled with one or more client devices 100 over the internet 12. Accordingly, the server 20 can be configured as an application server, a web server that hosts websites, or both.

It is noted that, while the one or more servers 20 is schematically depicted in FIG. 1 as being a single machine, each of the one or more processors 22, the memory 24, and the network interface hardware 26 can be distributed amongst a plurality of machines that are communicatively coupled to one another. Accordingly, the one or more servers 200 can be scaled to include any number of machines suitable for supporting any number of client devices 100.

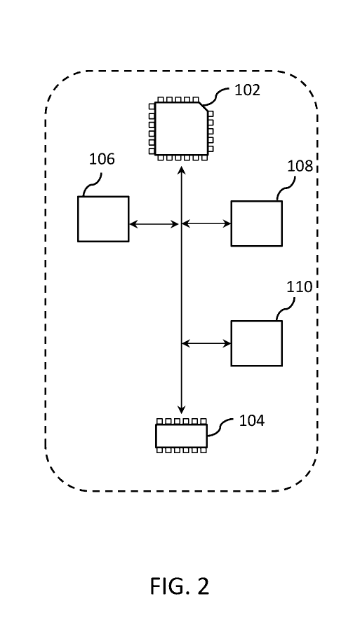

Referring collectively to FIGS. 1 and 2, the client device 100 can include any device capable of being communicatively coupled to the server 20. The client device 100 can include various machines such as, for example, a smart phone, a tablet, a laptop computer, desktop computer, or a specialized machine having communication capability. The client device 100 can include one or more processors 102 for executing machine readable instructions to perform functions according to the methods described herein. Specific examples of the one or more processors 102 can include a touch screen controller, a baseband controller, graphics processor, application processor, image processor, central processing unit, or the like. The client device 100 can further memory 104 communicatively coupled to the one or more processors 102.

The client device 100 can include network interface hardware 106 communicatively coupled to the one or more processors 104 for communicatively coupling the client device 100 to the server 20 via a network. Alternatively or additionally, the network interface hardware 106 can include radio frequency hardware (RF hardware) communicatively coupling the client device 100 with a cellular network. Suitable cellular networks include, but are not limited to, technologies such as LTE, WiMAX, UMTS, CDMA, and GSM. In some embodiments, the RF hardware can include components suitable for communicating voice information and data signals such as, for example, modems, attenuators, antennas, antenna switches, amplifiers, receivers, transceivers, or combinations thereof.

The client device 100 can include a display 108 communicatively coupled to the one or more processors 102 for providing optical signals and conveying visual feedback to users of the client device 100. In some embodiments, the display 108 can be configured to selectively illuminate a plurality of pixels to provide the optical signals. Accordingly, the display can include light emitting diodes (LED or OLED), liquid crystal display (LCD), liquid crystal on silicon (LCOS), or the like. Additionally, the display 108 can be configured to operate as a touch screen for accepting tactile input via visual controls. Accordingly, the display 108 can include a touch detector such as, for example, a resistive sensor, capacitive sensor, or the like. It is noted that the term “signal,” as used herein, can mean a waveform (e.g., electrical, optical, magnetic, or electromagnetic), such as DC, AC, sinusoidal-wave, triangular-wave, square-wave, and the like, capable of traveling through a medium. It should be understood that the term “optical” can refer to various wavelengths of the electromagnetic spectrum such as, but not limited to, wavelengths in the ultraviolet (UV), infrared (IR), and visible portions of the electromagnetic spectrum.

The client device 100 can include one or more input components 110 for sensing input and encoding the input into a signal indicative of the input. Suitable examples of the input component 100 can include a microphone, a button, a knob, a switch, a resistive sensor, capacitive sensor, a microphone, a keyboard, or the like. Alternatively or additionally, the display 108 can be configured to receive user input and operate as the input component 110. In addition to the aforementioned components, the client device 100 can include one or more additional components communicatively coupled to the one or more processors 104 without departing from the scope of the embodiments described herein. Suitable additional components include, but are not limited to, speakers, accessory lights (e.g., LED), motion sensors, optical sensors, Global Positioning System (GPS) receivers, or the like.

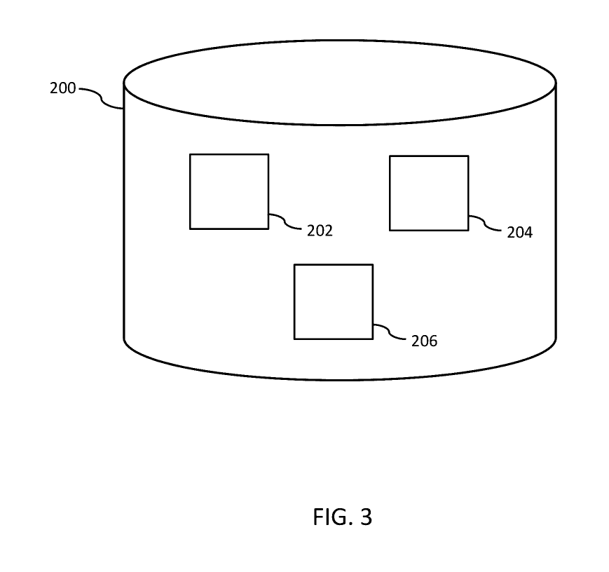

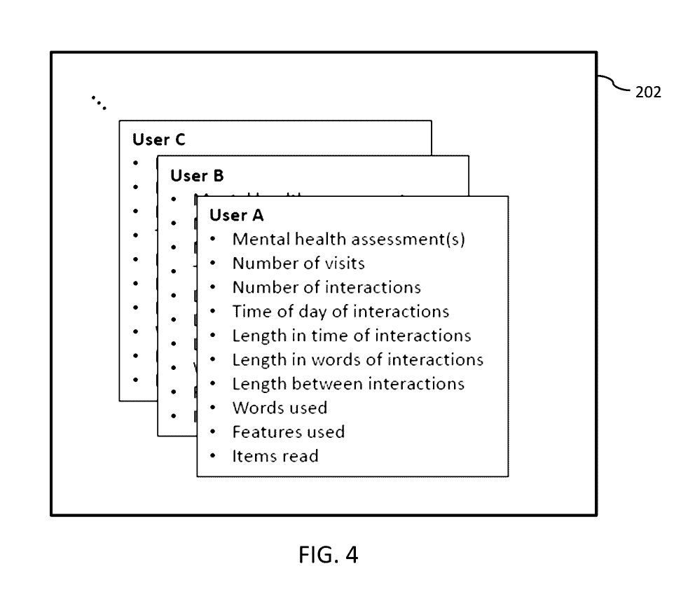

Referring collectively to FIGS. 1, 3, and 4, the system 10 can empower trained professionals to offer an increased level of service to users by making determinations regarding the mental states of users based on user interactions with the online support and recovery network. In some embodiments, the system 10 can include a data store 200. The data store 200 can be provided on memory 24 of the one or more servers 20. The data store 200 can be a repository for persistently storing and managing collections of data. For example, the data store 200 can include a user information database 202 configured to store information regarding the user interactions with the system 20 in a relational manner. Exemplary information can include user information (e.g., age, gender, and the like), mental health assessment results, mental health estimates, number of visits, number of interactions, time of day of the interactions, length in words of interactions, length between interactions, words used, features used, items read, or the like.

The data store 200 can include interface element data 204 configured to provide data related to visually perceptible elements of an interface such as, for example, a web page or a mobile app. Accordingly, the interface element data 204 can correspond to “look and feel” information for an interface. In some embodiments, the interface element data 204 can define visually perceptible objects, visually perceptible controls, or both. Accordingly, the server 20 can be configured to construct and provide an interface having objects and controls from the interface element data 204.

According to the embodiments provided herein, the data store 200 can include mental health assessment data 206 that defines questionnaires provided by the system 10. The questionnaires may have been shown (for example, in peer-reviewed research) to be reliable and valid measures of mood disorders such as, for example, anxiety; anxiety about health; concern regarding drinking, drug use, and/or eating; depression; fear and phobias; general distress; loss or trauma; obsessive and compulsive tendencies; issues regarding self-esteem; insomnia and other sleep disorders; social fear, etc. In some embodiments, the system 10 can be configured to provide a user interface for administering the questionnaire according to the mental health assessment data 206. For example, the system 10 can be realized by machine readable instructions accessible to and executed by the server 10 and/or downloaded and executed by the client device 100.

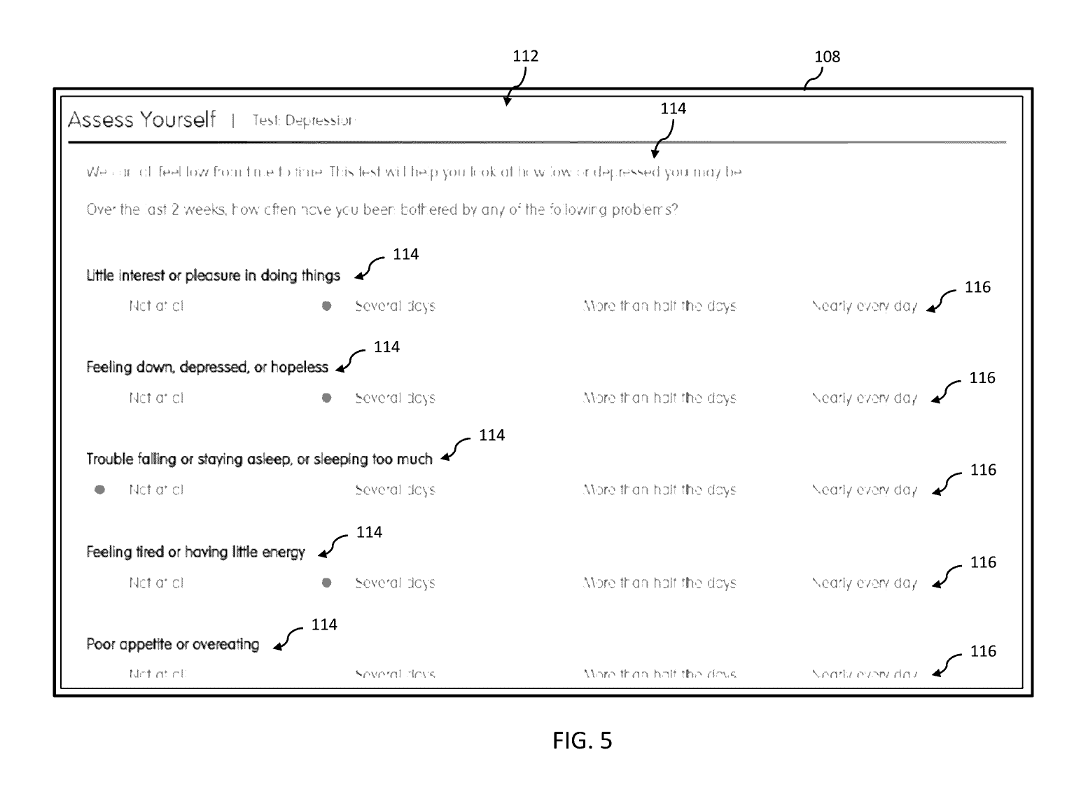

Referring collectively to FIGS. 1-5, the system 10 can provide a user interface 112 upon the display 108 of a client device 100. The user interface 112 can be configured to administer a depression questionnaire according to mental health assessment data 206. For example, the depression questionnaire can correspond to the 9-question Patient Health Questionnaire (PHQ-9). The PHQ-9 is a self-administered questionnaire—developed by Kurt Kroenke, Robert L. Spitzer, and Janet B. W. Williams—that is generally accepted within the mental health profession primarily to monitor the severity of depression and response to treatment and secondarily to make a tentative diagnosis of depression. The user interface 112 for the depression questionnaire can provide questions and instructions as objects 114 associated with text. Each of the questions can be associated with one or more controls 116 configured to receive user input indicative of a response to the question via the input component 110 of the client device 100. The user input can be scored to quantify a mental health assessment result indicative of the severity of the depression. For example, a score above 20 can be indicative of severe depression. The mental health assessment result can be stored in the user information database 202 in association with the user information of the user.

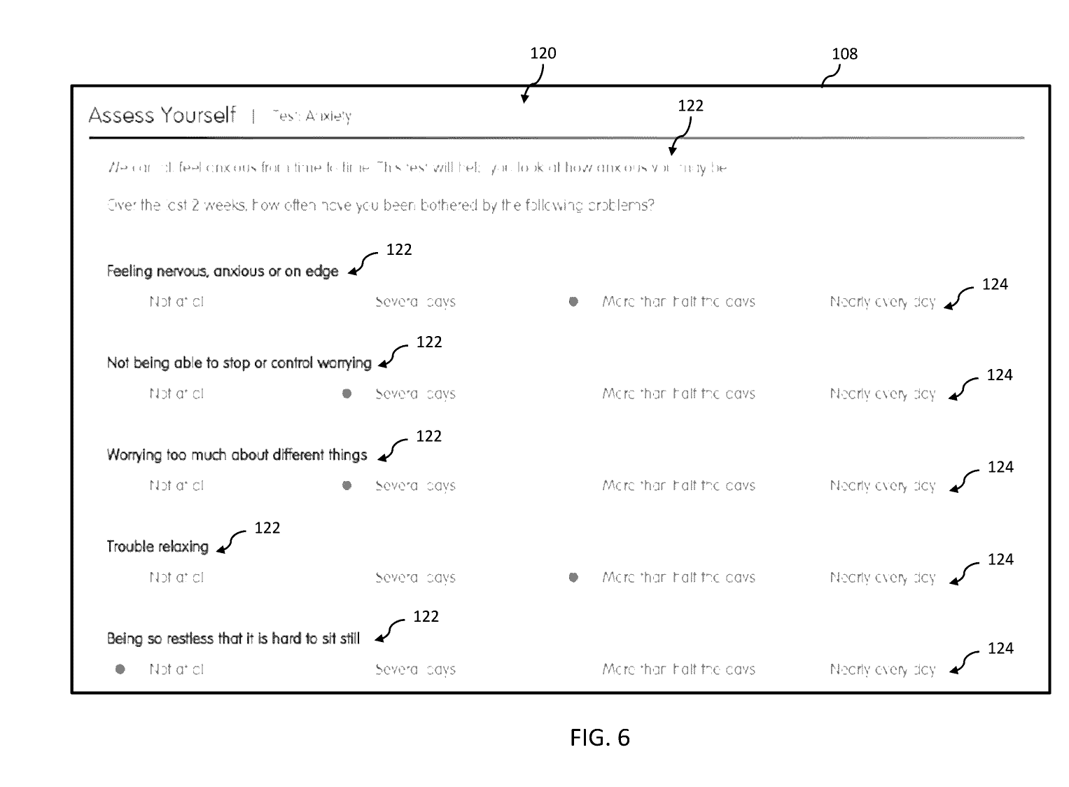

Referring collectively to FIGS. 1, 2, 3, and 6, the system 10 can be configured to administer an anxiety questionnaire according to mental health assessment data 206. For example, a user interface 120 can be provided upon the display 108 of a client device 100. The user interface 120 can include objects 122 for providing instructions and questions, and controls 124 for receiving input with the input component 110 of the client device 100. The user input can be scored to quantify a mental health assessment result indicative the severity of the anxiety, and the score can be stored in the user information database 202. In some embodiments, the anxiety questioner can correspond to the 7-item Generalized Anxiety Disorder Questionnaire (GAD7), a screening tool and severity measure for generalized anxiety disorder developed by Spitzer, Kroenke, Williams, and Bernd Lowe. While particular examples of mental health assessment data 206 corresponding to depression and anxiety are provided herein, the system 10 can be configured to provide questionnaires for quantifying any mental state such as, for example, anxiety about health, fear and phobias, general distress, loss or trauma, obsessive/compulsive tendencies, issues regarding self-esteem, insomnia and other sleep disorders, social fear, etc., as well as concern regarding drinking, drug use, eating, etc.

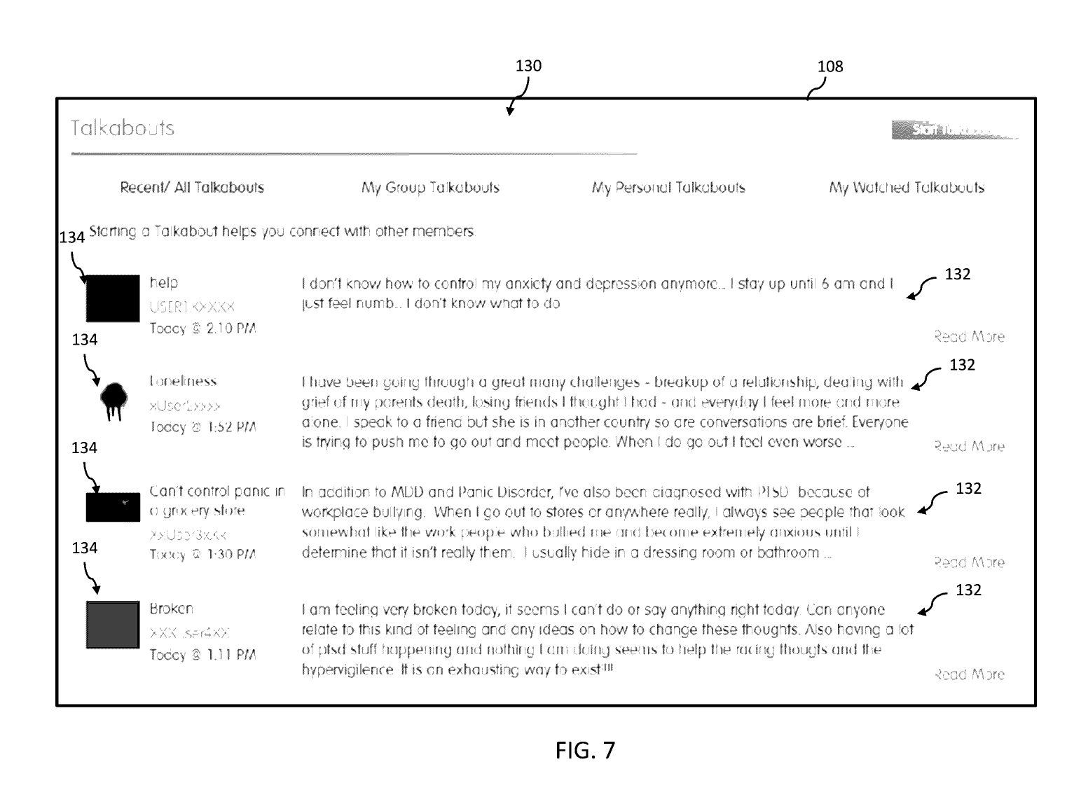

Referring collectively to FIGS. 1, 2, 3, 4, and 7, the system 10 can be configured to collect user interaction using social interfaces provided according to the interface element data 204. In contrast to the questionnaires, which can be clinical in nature, the social interfaces can be configured to elicit casual and unbiased interactions with the system 10. In some embodiments, a user interface 130 for providing a message board can be provided upon the display 108 of a client device 100. The user interface 130 can be configured to enable users to communicate with one another (e.g., regarding about their feelings and experiences). For example, users can interact with the system 10 by posting comment objects 132, which can include words providing a description of the post (e.g., title and comments). In some embodiments, the comments can be provided by the client device 100, which can receive input with the input component 110.

In some embodiments, interactions via the user interface 130 can be anonymous. Specifically, each comment object 132 can be associated with an identification object 134. The identification object 134 can be unique to the system 10 and can be configured to obscure the identity of the user. For example, the identification object 134 can include a user name and a user avatar. The interactions with the user interface 130 (e.g., input to the comment objects 132, identification objects 134, or both) and parameters of the interaction (e.g., number of visits, number of interactions, time of day of the interactions, features used, items read, length of time between the interactions, number of words, etc.) can be stored in the user information database 202 in association with the user information. In some embodiments, the identification object 134 can be monitored, by individuals and/or an automated system, to prevent users from sharing information that can be used to identify the user. Alternatively or additionally, the user interface 130 can be monitored by trained professionals to provide emotional support to users.

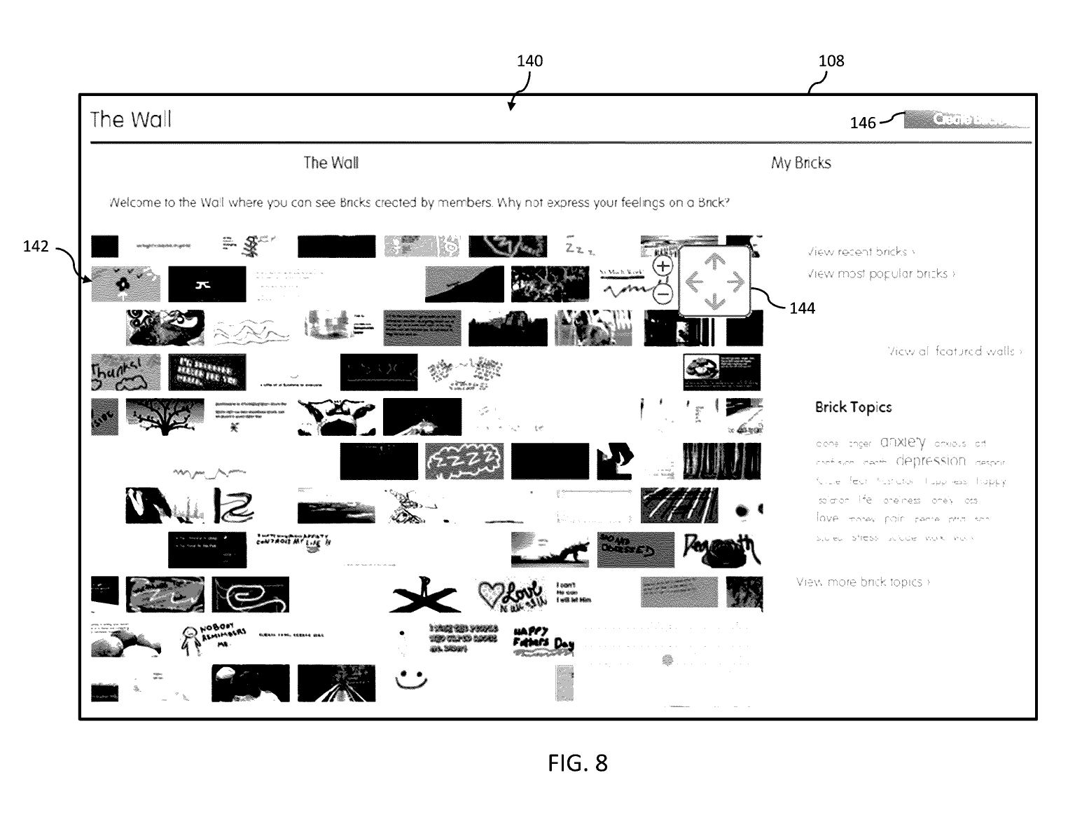

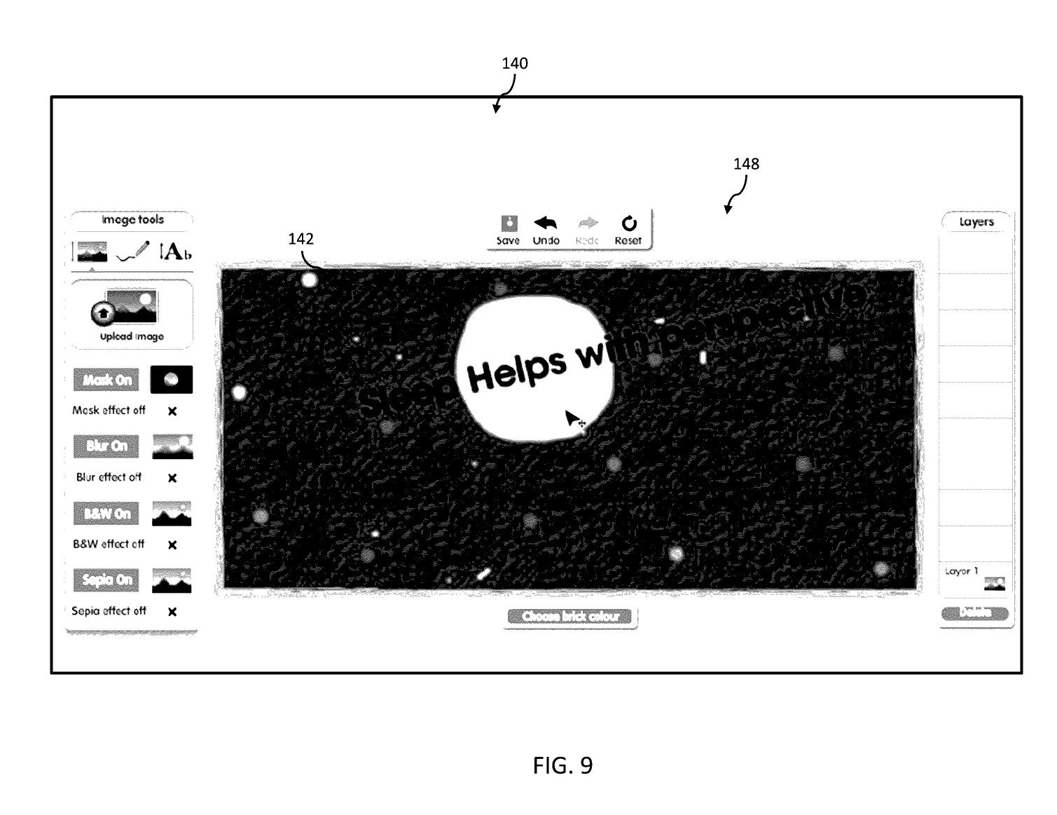

Referring collectively to FIGS. 1, 2, 3, 4, 8, and 9, the system 10 can be configured to provide a user interface 140 for creating and sharing picture objects 142 according to the interface element data 204. In contrast to the questionnaires, which can be clinical in nature, the picture objects 142 can be configured to elicit casual and unbiased interactions with the system 10. The user interface 140 can be provided upon the display 108 of a client device 100. The user interface 140 can include a collection of picture objects 142 generated by users, which can be navigated by, for example, scrolling or changing the size (i.e., zoom) with a navigation control 144 of the user interface 142. In some embodiments, the picture objects 142 can be configured to interact with users. For example, each picture object 142 can be configured to receive hover or selection input via the input component 110. Responsive to the input, a selected picture object 142 can be enlarged. The parameters of the interaction with the user interface 140 can be stored in the user information database 202 in association with the user information.

The user interface 140 can include a picture creation control 144 for receiving text user input, graphical user input, or both. Responsive to user input received by the picture creation control 144, a picture creation tool 148 can be provided upon the display 108 of a client device 100. The picture creation tool 148 can be configured to interact with users and provide functionality for users to create the picture objects 142. Specifically, the creation tool 148 can include controls for interacting with the user to upload images, apply image effects, add text, add freehand shapes, or the like. Once created, the picture object 142 can be shared for viewing with the community of users. The interactions with the picture creation tool 148 and parameters of the interaction can be stored in the user information database 202 in association with the user information. The picture objects 142 can be configured to promote anonymity of the user. In some embodiments, the picture objects 142 can be monitored, by individuals and/or an automated system, to prevent users from sharing information that can be used to identify the user. Alternatively or additionally, the user interface 140 can be monitored by trained professionals to provide emotional support to users.

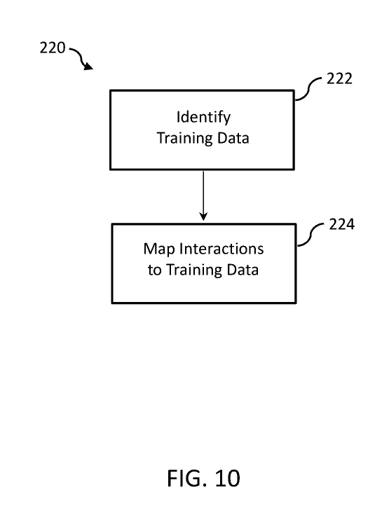

Referring collectively to FIGS. 1, 3, 4, and 10, the system 10 can include an assessment model 210 configured to generate mental health estimates according to user interactions with the system 10. In some embodiments, the assessment model 210 can generate a mental health estimate without requiring a user to respond to questionnaires provided according to the mental health assessment data 206. Specifically, the assessment model 210 can be trained using a machine learning algorithm configured to map input observations of a training data set to output observations of the training data set. Accordingly, the assessment model 210 can be configured to make predictions from input data, rather than simply following static program instructions. Suitable machine learning techniques include, but are not limited to, neural networks, logistic regression, random forest method, or the like. Once the assessment model 210 is trained, the assessment model can be provided on memory 24 and executed automatically by the one or more processors 102 to generate mental health estimates. Additionally it is noted, that the assessment model 210 can be trained periodically such as, for example, when more data is available for use as a training data set.

The assessment model 210 can be trained according to method 220. Method 220 can include a process 222 for identifying training data. At process 22, the system 10 can analyze the user information database 202 to identify user information that is associated with mental health assessment results. For example, the mental health assessment results can be analyzed to determine if the mental health assessment results are indicative of a particular mental state (e.g., anxiety, depression, etc.). In some embodiments, the system 10 can differentiate between mental health assessment results indicating mental states of varying severity. In one example, mental health assessment results of the PHQ-9 having a score above 20 can be indicative of severe depression.

At process 224, the assessment model 210 can be trained to map the interactions to the mental health assessment results. For example, the assessment model 210 can develop a profile of interactions that are correlated to mental health assessment results indicating a particular mental state. Specifically, the user information, the interactions, the parameters of the interactions, or combinations thereof in association with the identified the mental health assessment results can be used as inputs. Accordingly, the training data can provide the user information, the interactions, the parameters of the interactions, or combinations thereof as input and the corresponding mental health assessment results as output to train the assessment model 210. Thus, the assessment model 210 can be trained to transform the user information, the interactions, the parameters of the interactions, or combinations thereof into a mental health estimate that estimates the mental health assessment results.

In some embodiments, the assessment model 210 can be trained to estimate which inputs are indicative of a mental state based on a combination of two factors: (i) the correlation of a particular input with an input corresponding to mental health assessment results indicative of the mental state; and (ii) the total number of users of that exhibit the particular input. For example, the system 10 can create n-grams (i.e., combinations of sequential words) such as 2-grams (i.e., combinations of 2 sequential words) corresponding to words extracted from the user information database 202. “Stop words” such as I, to, we, html coding, punctuation, etc. can be removed from the n-grams. The words can be converted to lower case for ease of processing, and can be Porter stemmed. Additionally, the system 10 can ignore all n-grams used by a number of users less than a threshold of users, even if those n-grams are highly correlated with a particular mental state. Moreover, the system 10 can ignore n-grams used by a high number of users if those n-grams were found to have a low correlation with a particular mental state.

Accordingly, the assessment model 210 can be used for diagnosis without using questionnaires provided according to the mental health assessment data 206. In some embodiments, the system 10 can analyze the user information database 202 with the assessment model 210 to automatically generate mental health estimates for users based upon the user information, the interactions, the parameters of the interactions, or combinations thereof. The mental health estimates can be stored in the user information database 202 in association with the user information. Accordingly, the mental health estimate can be used to direct users to message boards, collections of picture objects, or tools for managing the mental state (anxiety; anxiety about health; concern regarding drinking, drug use, and/or eating; depression; fear and phobias; general distress; loss or trauma; obsessive and compulsive tendencies; issues of self-esteem; insomnia and other sleep disorders; social fear; etc.) corresponding to the mental health estimate.

Alternatively or additionally, the system 10 can automatically direct users to online courses designed to help users manage issues related to the mental state corresponding to the mental health estimate. Each of the courses provided by the service can be clinically proven to help individuals manage mental health issues such as anxiety, depression, etc., or specific behavioral goals such as smoking cessation, weight management, etc. In some embodiments, the online courses can include interaction with health professionals.

The system 10 can also group individuals based on related mental health issues and/or causes of mental health issues to, for example, identify the needs of the online community for additional services, create tailored services for specific groups of users, monitor changes in usage and effectiveness of the online service for different patient groups, and/or identify groups of users that are not being well served by the online service and implement specific services for those groups.

The system 10 can also make a determination regarding the severity of a user's mental health issues to, for example, measure and track changes in the severity of a user's mental health issue(s), reduce the need for a user to obtain (formal or informal, online or offline) psychometric assessments, provide an estimate of the severity and causes of the user's mental health issue(s) to the user, and/or determine the effectiveness of online or offline services.

The system 10 can also make determinations regarding the mental health of the entire online community to, for example, make informed short term tactical responses (e.g., schedule of an appropriate number of clinical staff to monitor online interactions), measure and track changes regarding the mental health of the entire online community, make informed long term planning decisions, and/or better understand the entire population of users (e.g., by enabling geographic and/or other segmentations).

The system 10 can also make connections between the language/behavior of users and identified mental health issues to, for example, identify and reach out to other online or offline communities and groups, identify users of other online services that can be receptive to marketing information regarding the online service, and/or provide guidance to individuals regarding keywords and triggers that might suggest specific mental health issues or severity of mental health issues.

An exemplary assessment model for predicting depression was trained and tested. Two groups of users were identified: users that self-administered the PHQ-9 and received a score greater than or equal to 20 and users that self-administered the PHQ-9 and received a score less than 20. The words used by users of both groups were evaluated. The system created n-grams (i.e., combinations of sequential words) such as 2-grams (i.e., combinations of 2 sequential words) corresponding to the words. “Stop words” were removed from the n-grams. Users with less than a predetermined number of n-grams (e.g., less than twenty 2-grams) were excluded from the data set. Each group of users was subdivided into a training sample and a test sample. Specifically, 20 percent of the sample users were used as a test sample, while the remaining 80 percent of the sample users were used to train the assessment model to estimate depression.

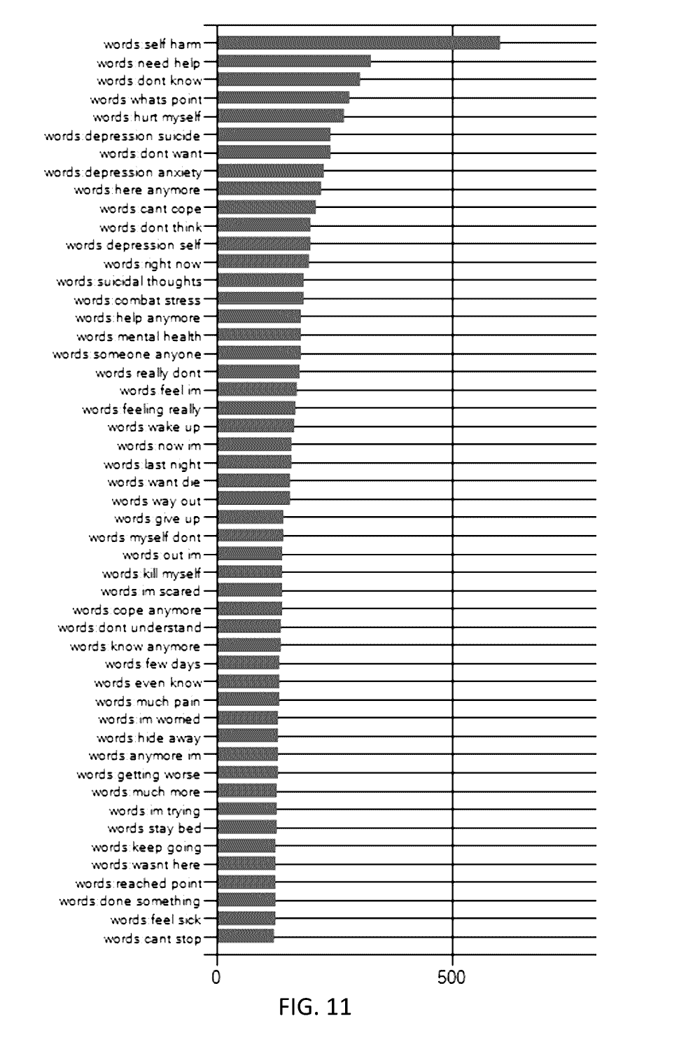

Using the method and the test sample, a correlation between certain 2-word phrases and a mental state of severe depression was discovered. FIG. 11 illustrates 2-grams used by users with PHQ-9 scores greater than or equal to 20 according to the tested embodiment. As shown in FIG. 11, users with PHQ-9 scores greater than or equal to 20 were found to be more likely to use two-word phrases such as “self harm,” “need help,” “don't know,” etc. For users that have submitted 20 or more words, the mental health estimates were found to have an Area Under Curve (AUC) score of 0.873, which indicated good correlation with the mental health assessment results (an AUC score of 1 being perfect correlation). Accordingly, the tested model identified 50 users in the test sample most likely to be suffering from severe depression and 45 of those 50 users received a PHQ-9 score greater than or equal to 20. The tested model also identified 50 users least likely to be suffering from severe depression and 48 of those users received a PHQ-9 score under 20. The mental health estimates were found to be more accurate for users that used more words. It was discovered that predictions for users that used 10 or more words had an AUC score of 0.817, predictions for users that used 50 or more words had an AUC score of 0.907, and predictions for users that used 100 or more words had an AUC score of 0.919.

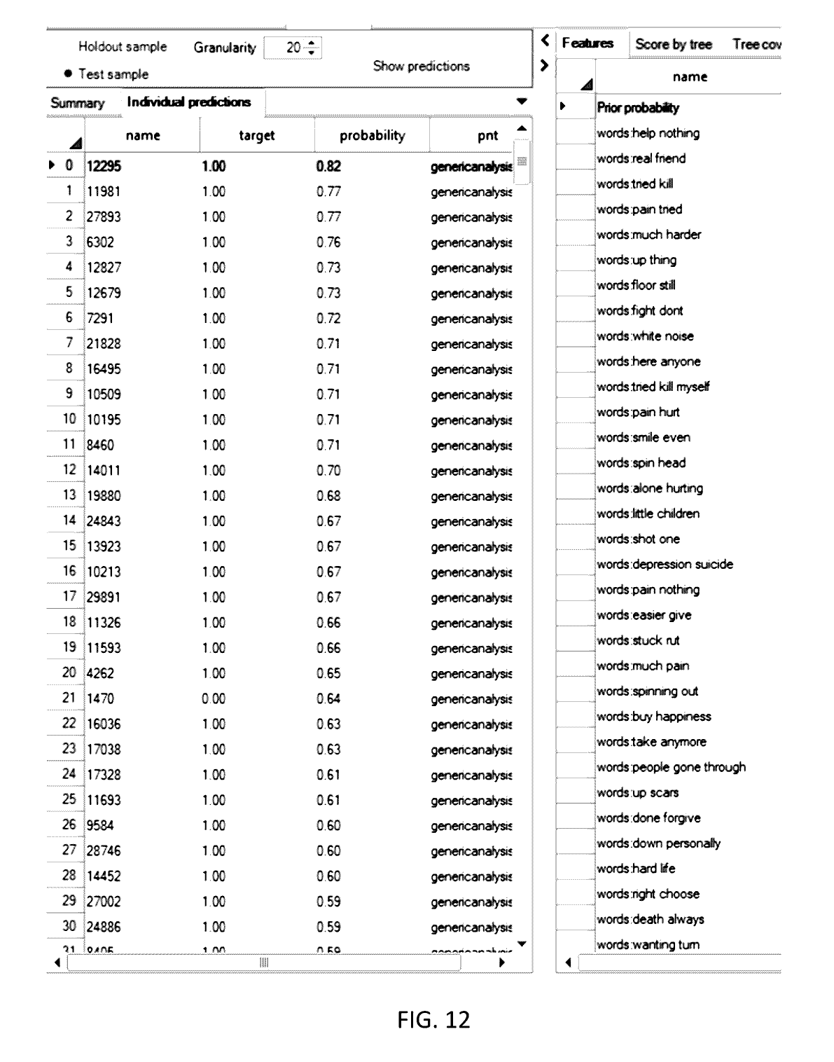

FIG. 12 graphically depicts the mental health estimates, predicted by the tested model, indicative of users having a high probability of severe depression. Specifically, the tested model determined that user 12295 had an 82 percent probability of suffering from severe depression, user 11981 had a 77 percent probability, etc. The determinations can be used to, for example, provide personalized online treatment such as interventions from clinical staff, provide online and/or offline support mechanisms, connect users with similar mental health issues and/or similar levels of severity, and/or inform individuals (e.g., other users of the online service or offline contacts of the user) regarding the need for additional support.

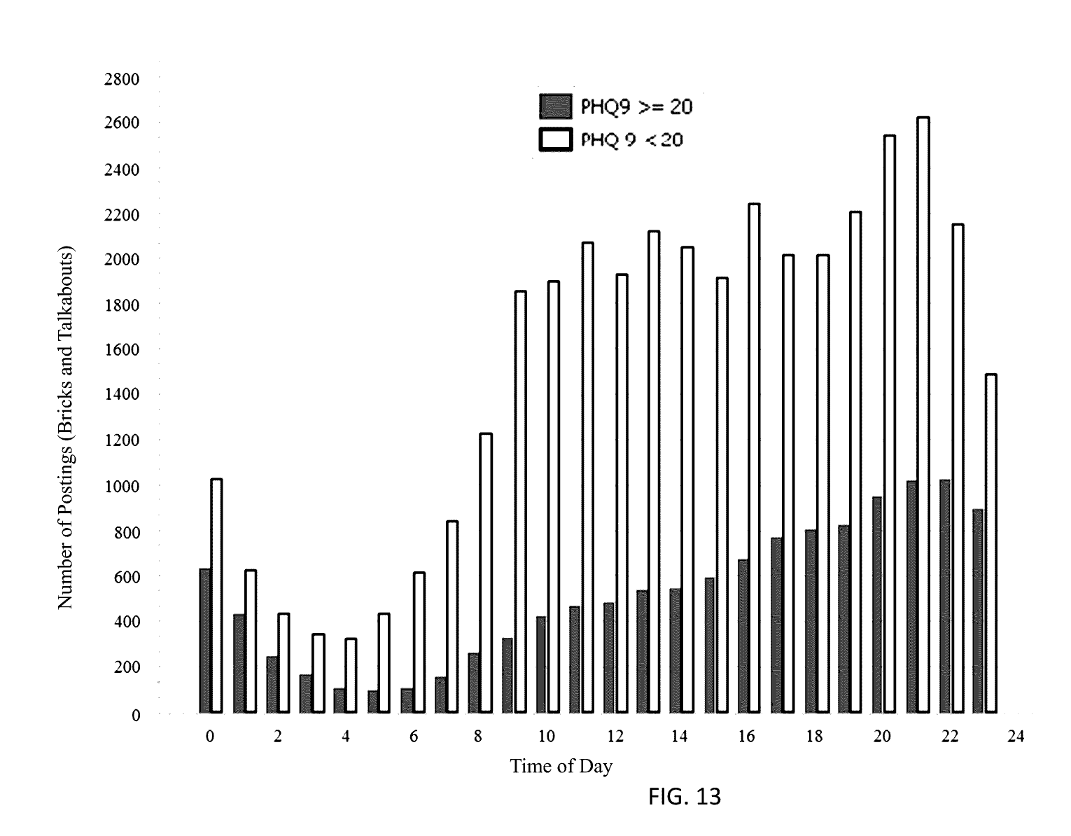

As is noted above, the mental state of users can be estimated from the time of day and time of week of user submissions. FIG. 13 is a graph illustrating the absolute number of user submissions (picture object submissions and message board postings) by time of day as recorded from the test data set. More specifically, FIG. 13 illustrates a comparison of users that self-administered the PHQ-9 and received a score greater than or equal to 20 and users that self-administered the PHQ-9 and received a score less than 20.

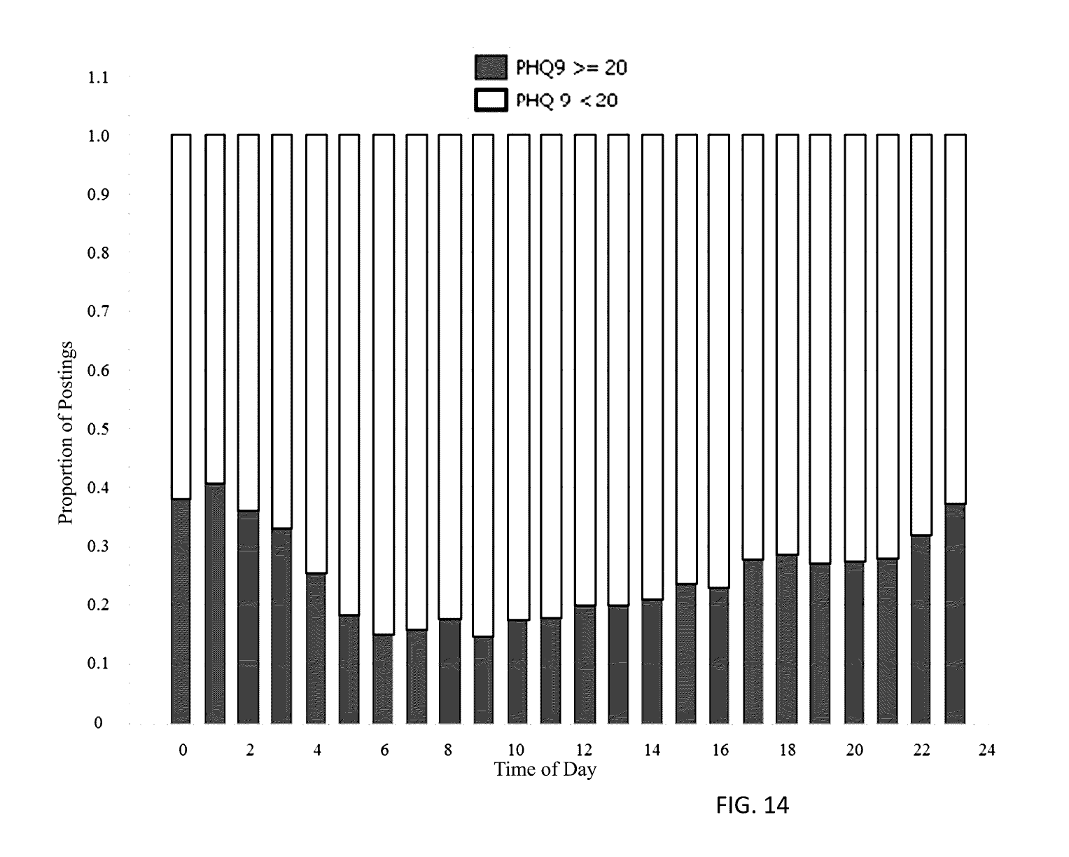

FIG. 14 is a graph comparing the relative number of user submissions from users with a PHQ-9 score greater than or equal to 20 and users with a PHQ-9 score less than 20 as recorded from the test data set. The number of users submissions for both groups is highest in the evening. However, the relative number of submissions (i.e., the share of total submissions of all users with a PHQ-9 score) from users with PHQ-9 scores greater than or equal to 20 is higher between 10 p.m. and 3 a.m. than at other times of the day. Accordingly, if a user that has not self-administered the PHQ-9 is more active between 10 p.m. and 3 a.m. relative to other users, that user behavior can contribute to a determination by the model that the user may be suffering from severe depression.

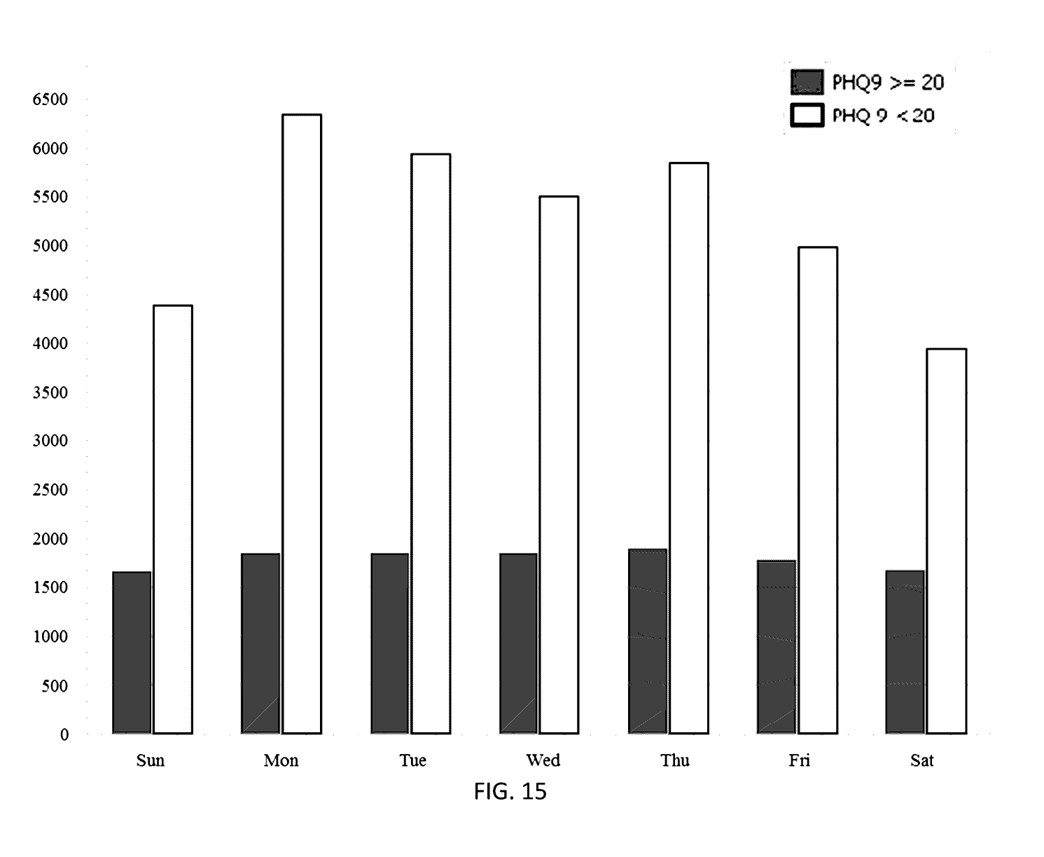

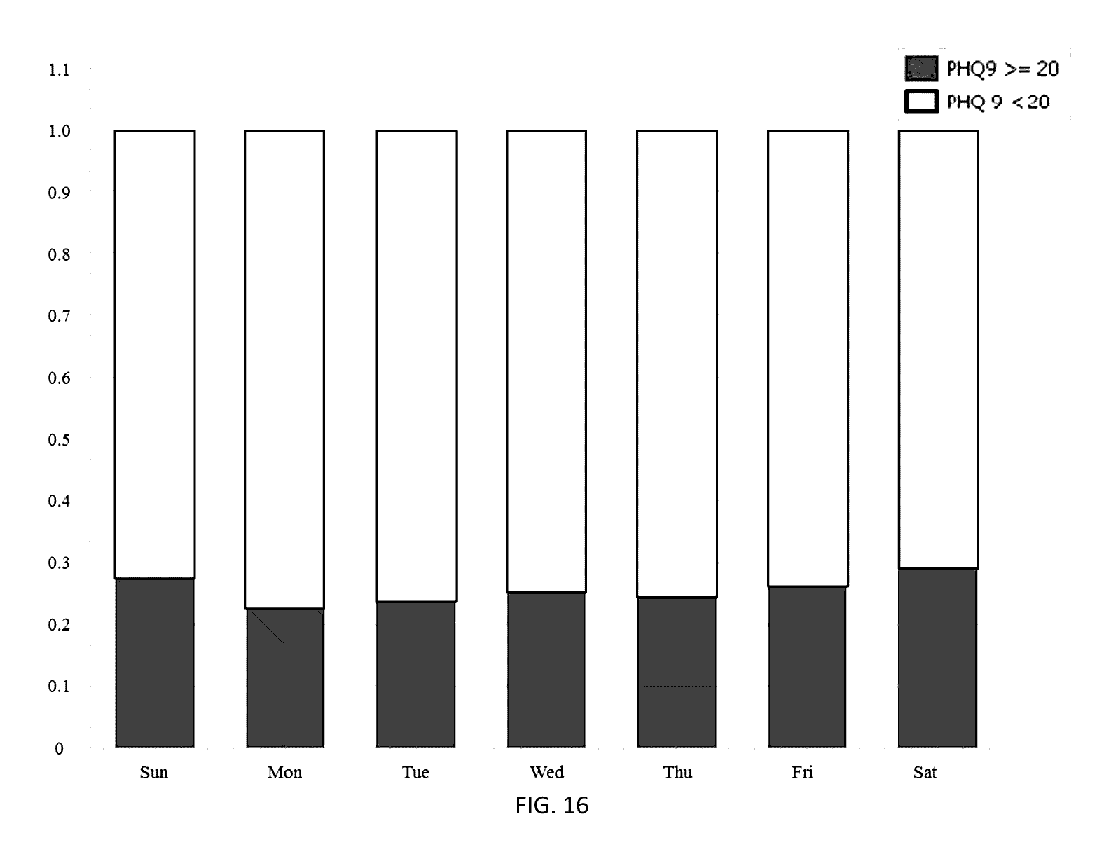

FIG. 15 is a graph illustrating the absolute number of user submissions by day of the week as identified by the test data set. FIG. 16 is a graph illustrating the relative number of user submissions by day of the week as identified by the test data set. As illustrated in FIGS. 15 and 16, users with a PHQ-9 score below 20 used the system less on the weekend, while users with a PHQ-9 score greater than or equal to 20 used the system consistently throughout the week. Accordingly, if a user that has not self-administered the PHQ-9 consistently uses the system throughout the week (i.e., the number of postings on Saturdays and Sundays is substantially equal to the number of postings on other days), that user behavior may contribute to a determination by the model that the user may be suffering from severe depression.

It should now be understood that embodiments provided herein can provide assessment models that can use social interfaces to elicit casual and unbiased interactions to estimate mental health assessment results. The social interfaces can provide a user interface with visually perceptible elements that have the look and feel of social networking websites or applications. Accordingly, users who do not desire to respond to questionnaires can still receive mental health estimates. Indeed, in many cases users may not wish to respond to questionnaires because of their formal and clinical nature. Additionally, even anonymous questionnaires can imply to users that the results are not completely anonymous. Accordingly, many users may feel reluctant to respond to such questionnaires.

Since the embodiments described herein provide user interfaces that have the look and feel of social networking interfaces, they give the user the impression that she is interacting with a non-clinical interface. Further, the user is able to be diagnosed without being redirected to a questionnaire, thus allowing the system to continue to interact with the user and maintain some control over the user. Accordingly, the embodiments provided herein enable the system to diagnose all of the users, but without the loss of users who do not desire to interact with a questionnaire.

Alternatively or additionally, the user interfaces provided herein can be configured to obscure the diagnostic nature of the user interface, i.e., the user interface may give no indication that mental health estimates are being determined. Accordingly, a user may be unaware of the particular inputs provided to the assessment model, and can provide less biased interactions without feeling the scrutiny of a mental health questionnaire. Moreover, users can avoid the need to select an appropriate mental health questionnaire, which can require a certain level of self-diagnosis and selection bias. For example, users may be reluctant to admit to even needing to use a certain type of questionnaire for diagnosing disorders. Thus, it is believed that the assessment model can yield good results due to the unbiased nature of the interactions and by automatically matching users to the appropriate type of diagnosis. It is furthermore believed that ease of use and increased user participation can improve the accuracy of the assessment model by providing additional training data for retraining or continuously training the assessment model.

It is noted that the terms “substantially” and “about” can be utilized herein to represent the inherent degree of uncertainty that can be attributed to any quantitative comparison, value, measurement, or other representation. These terms are also utilized herein to represent the degree by which a quantitative representation can vary from a stated reference without resulting in a change in the basic function of the subject matter at issue.

While particular embodiments have been illustrated and described herein, it should be understood that various other changes and modifications can be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for estimating mental health assessment results, the system comprising:
a data store comprising interface element data defining visually perceptible elements and a user information database defining interaction information and mental health assessment results for a plurality of users, wherein the mental health assessment results are indicative of at least one mental state;
an assessment model trained to map the interaction information of the user information database to the mental health assessment results of the user information database; and
a server communicatively coupled to the assessment model and the data store, wherein the server executes machine readable instructions to:
retrieve the visually perceptible elements from the interface element data of the data store;
provide a user interface comprising the visually perceptible elements upon a display of a client device;
receive from the client device data indicative of user interaction with the user interface;
input the data indicative of user interaction to the assessment model; and
determine a mental health estimate using the assessment model, wherein the mental health estimate estimates the mental health assessment results of the user information database.

2. The system of claim 1, wherein the at least one mental state is anxiety and the mental health assessment results are determined with a 7-item Generalized Anxiety Disorder Questionnaire.

3. The system of claim 1, wherein the at least one mental state is depression and the mental health assessment results are determined with a 9-question Patient Health Questionnaire.

4. The system of claim 1, wherein the data indicative of user interaction comprises text input, graphical input, or both.

5. The system of claim 1, wherein the data indicative of user interaction comprises interaction parameters.

6. The system of claim 5, wherein the interaction parameters comprise a number of visits, a number of interactions, time of day, features used, items read, length of time between interactions, or a combination thereof.

7. The system of claim 1, wherein the interaction information comprises text input, graphical input, or both.

8. The system of claim 1, wherein the interaction information comprises interaction parameters.

9. The system of claim 8, wherein the interaction parameters comprise a number of visits, a number of interactions, time of day, features used, items read, length of time between interactions, or a combination thereof.

10. The system of claim 1, wherein the assessment model is trained with n-grams extracted from the interaction information of the user information database.

11. A method for estimating mental health assessment results, the system comprising:
providing a data store comprising interface element data defining visually perceptible elements and a user information database defining interaction information and mental health assessment results for a plurality of users, wherein the mental health assessment results are indicative of at least one mental state;
providing an assessment model trained to map the interaction information of the user information database to the mental health assessment results of the user information database;
retrieving, automatically with a server, the visually perceptible elements from the interface element data of the data store, wherein the server is communicatively coupled to the assessment model and the data store;
providing, automatically with the server, a user interface comprising the visually perceptible elements upon a display of a client device;
receiving, automatically with the server, data indicative of user interaction with the user interface from the client device;
inputting, automatically with the server, the data indicative of user interaction to the assessment model; and
determining, automatically with the server, a mental health estimate using the assessment model, wherein the mental health estimate estimates the mental health assessment results of the user information database.

12. The method of claim 11, wherein the at least one mental state is anxiety and the mental health assessment results are determined with a 7-item Generalized Anxiety Disorder Questionnaire.

13. The method of claim 11, wherein the at least one mental state is depression and the mental health assessment results are determined with a 9-question Patient Health Questionnaire.

14. The method of claim 11, wherein the data indicative of user interaction comprises text input, graphical input, or both.

15. The method of claim 11, wherein the data indicative of user interaction comprises interaction parameters.

16. The method of claim 15, wherein the interaction parameters comprise a number of visits, a number of interactions, time of day, features used, items read, length of time between interactions, or a combination thereof.

17. The method of claim 11, wherein the interaction information comprises text input, graphical input, or both.

18. The method of claim 11, wherein the interaction information comprises interaction parameters.

19. The method of claim 18, wherein the interaction parameters comprise a number of visits, a number of interactions, time of day, features used, items read, length of time between interactions, or a combination thereof.

20. The method of claim 11, wherein the assessment model is trained with n-grams extracted from the interaction information of the user information database.
